(19) United States
(12) Patent Application Publication
(10) Pub. No.: US 2005/0143280 A1
(43) Pub. Date: Jun. 30, 2005

(54) Rinse-aid composition

(76) Inventors: Andrew Paul Nelson, Newcastle/Tyne (GB); Jun Wang, Newcastle upon Tyne (GB); Anju Deepali Massey Brooker, Newcastle upon Tyne (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/018,819

(22) Filed: Dec. 21, 2004

(30) Foreign Application Priority Data
Dec. 29, 2003 (EP) 03029914.3
Dec. 1, 2004 (EP) 04257478.0

(51) Int. Cl. C11D 1/00

(52) U.S. Cl. 510/466

(57) ABSTRACT

A substantially non-aqueous concentrated rinse-aid composition for the heat-free drying of plastic-ware and other dishwashing items, the composition comprising at least 20% by weight of one or more super-wetting surfactants. The composition provides excellent finishing and care of the dishwashing load.

### CROSS REFERENCE

This case claims priority to European Application Serial No. 03029914.3 filed Dec. 29, 2003.

### TECHNICAL FIELD

The present invention is in the field of dishwashing, in particular it relates to rinse-aid compositions and uses thereof. The compositions provide drying, finishing and care benefits for the washed articles. The invention also relates to unit dose compositions and to dishwashing methods using the rinse-aid compositions.

### BACKGROUND OF THE INVENTION

Nowadays consumers not only expect a good cleaning from the automatic dishwashing process but also a good finishing of the cleaned articles. The process should also be mild enough to avoid damage to the articles. The variety of materials cleaned in automatic dishwashing machines is gradually increasing. Traditional loads include mainly glass, ceramic and metal articles. Current loads are increasingly including plastic and some wood articles.

An unmet need in the dishwashing process is the finishing of plastics, especially the drying. Usually at the end of the dishwashing process plastic items are still wet, requiring the further step of manual drying or standing before they can be stored.

Other problems currently found in the dishwashing process are related to care and appearance of the cleaned articles. The dishwashing process may promote glass and metal corrosion, and damage of patterned and wood articles. An additional issue is related to the appearance of the cleaned articles, sometimes, they present a lack of shine and a dull appearance, especially glass and metal articles. Another common problem is white spotting on Teflon articles.

U.S. Pat. No. 5,603,776 provides a method for cleaning plastic-ware in a dishwashing machine comprising the contacting of the plastic-ware with an aquous rinse comprising from 2 to 100 ppm of a non-ionic surfactant, 0.01 to 10 ppm of a fluorinated hydrocarbon surfactant and 0.01 to 10 ppm of a polyalkylene oxide-modified polydimethylsiloxane. However, the method of '776 does not solve the problems stated hereinabove.

In view of these problems, there is the need for a method of dishwashing which provides a good finishing of the cleaned articles whilst avoiding or reducing the damage on the articles.

### SUMMARY OF THE INVENTION

According to a first aspect of the present invention, there is provided a substantially non-aqueous concentrated rinse-aid composition for the heat-free drying of plastic-ware and other dishwashing items. The composition preferably comprises at least about 20%, more preferably at least about 25% by weight of one or more super-wetting surfactants, as defined herein below.

The term “substantially non-aqueous” as used herein is intended to include compositions containing less than about 20%, preferably less than about 15% and more preferably less than about 10% of water by weight of the composition.

The compositions herein are applied in the aqueous rinse cycle of an automatic dishwashing machine and are capable of totally drying plastic-ware and other dishwashing items in the subsequent drying cycle without the application of heat. More particularly, a composition is said to be useful for “heat-free drying of plastic-ware and other dishwashing items” when a rinse concentration of less than about 450 ppm, for example less than about 350 ppm, preferably less than about 300 ppm and more preferably less than about 200 ppm provides total drying of a polypropylene or polystyrene plastic sheet of 20 cm by 15 cm when placed vertically in the top rack of a GE500 dishwasher using the program called “normal” at a temperature of 37-50° C. without heating during the drying cycle.

The plastic sheet is visually evaluated 5 minutes after the end of the program (during this time the dishwasher remains closed). Total drying is achieved when the plastic sheet presents less than 5 droplets, preferably less than 3 droplets and more preferably no droplets at all. Plastic is one of the most difficult surfaces to dry among the surfaces found in a typical dishwashing load, therefore, it is expected that if plastic can be dried under certain conditions (including the presence of rinse aid) other items would also be.

A surfactant is generally considered to be “super-wetting” if a drop of an aqueous solution of 0.3%, preferably 0.03% by weight of the surfactant spreads spontaneously into an essentially uniform film on a smooth and planar plastic (e.g., polypropylene or polystyrene) surface in less than about 10 minutes, preferably in less than about 5 minutes, more preferably less than 3 minutes and especially after less than 1 minute. For the purpose of this invention whether a surfactant is super-wetting or no can be evaluated according to the following method: a drop, preferably a 20 μl drop, of the aqueous solution (distilled water) of the surfactant to be tested is created with a micropipette and deposited onto a horizontal smooth and planar polypropylene or polystyrene surface (for example a “crystal grade” polystyrene petri dish supplied by SPI) prewashed with distilled water and dried at room temperature, i.e., at 20° C. under 30%-40% humidity. The distance between the drop just releasing from the tip of the micropipette and the surface is about 3 mm. The diameter of the drop (or strictly the surface region wetted by the drop) after a specified time is measured with the help of an imaging medium (photographic camera) or the naked eye (a grid is placed under the petri dish in order to quantify the diameter of the drop): The test is then repeated using a drop of pure (deionised) water. A surfactant is considered to be super-wetting if the spreading factor (diameter of the surfactant solution/diameter of pure water solution) is greater than about 2, preferably greater than about 3, more preferably greater than about 4 and especially greater than about 8, after 5 minutes, preferably after 3 minutes, more preferably after 1 minute.

Preferably the super-wetting surfactants (0.3%, preferably 0.03% aqueous solution) have a contact angle of less than about 15°, preferably less than about 13° and more preferably less than about 11° on a polypropylene or polystyrene surface. Preferably the compositions of the invention (0.3%, preferably 0.03% aqueous solution) have a contact angle of less than about 16°, preferably less than about 140 on the polypropylene or polystyrene surface.

The contact angle can be measured by preparing an aqueous solution comprising 0.3%, preferably 0.03% by weight of the solution of the surfactant or rinse-aid composition to be measured. A FTA 200 contact angle measurement kit from First Ten Angstroms is used.

The measurements are carried out at room temperature on 2 cm×5 cm polypropylene (Polymex natural colour plastic shimstock, supplied by Plastic Shims & Gaskets Co. LTD.) or polystyrene strips. A drop of the solution is deposited onto a polypropylene or polystyrene strip by means of a syringe. The distance between the strip and the tip of the syringe is about 3-5 mm. The spreading pictures are taken with a CCD high-speed camera and analysed through the FTA 200 software.

Preferably, the compositions and super-wetting surfactants herein meet the above tests on at least one and preferably both of the above mentioned surfaces, polypropylene being preferred.

Super-wetting surfactants suitable for use herein include a range of siloxane and hydrocarbon based surfactants. In a preferred embodiment the super-wetting surfactant is selected from the group consisting of: i) polyoxyalkylene siloxanes wherein the polyalkylene oxide residue has the general formula (EO)ₙ(PO)ₘ wherein EO is ethoxy, PO is propoxy, n is at least about 3 and greater than m; ii) non-ionic ethoxylated alcohols having an average of from about 4 to about 10 moles of EO per mol of alcohol and an average chain length of from about 6 to about 15 carbon atoms; iii) and mixtures thereof. The non-ionic alkyl ethoxylated super-wetting surfactants are preferably free of propoxy groups.

Preferably the rinse-aid compositions of the present invention comprise a co-surfactant. The co-surfactant is not super-wetting in itself (on either polypropylene or polystyrene surfaces according to the above mentioned tests) and is mainly used for two different reasons: i) as a synergist or extender to minimise the amount of super-wetting surfactant required to achieve total drying; and/or ii) to suppress foam in the case of foaming super-wetting surfactants. Co-surfactants suitable for the first reason include non-ionic alkyl ethoxylated/propoxylated surfactants having a degree of ethoxylation higher than the degree of propoxylation and having an average of from about 4 to about 9 moles of EO per mol of alcohol, from about 1 to about 4 moles of PO per mol of alcohol and preferably at least about 25%, more preferably at least about 75% of surfactant having an alkyl chain being linear and containing from about 6 to about 15 carbon atoms. These co-surfactants preferably have a surface tension of from about 35 to about 27 mN/m as measured in a 1% by weight aqueous solution at 20° C. Preferably, these co-surfactants are low foaming.

Co-surfactants suitable for the second reason (non-ionic suds suppressers) include non-ionic surfactants having a low cloud point.

Preferably the co-surfactants have a contact angle (0.3%, preferably 0.03% aqueous solution) of from about 17° to about 35°, preferably from about 18° to about 22° on a polypropylene surface.

In a preferred embodiment the composition comprises at least about 10%, preferably at least about 20% by weight of the composition of a siloxane super-wetting surfactant and a co-surfactant, the super-wetting surfactant and the co-surfactant being in a ratio of from about 1:1 to about 1:5, preferably about 1:2. A preferred composition according to this embodiment comprises from about 10% to about 40%, preferably from about 20% to about 30% by weight of the composition of a siloxane, especially methyltrisiloxane, super-wetting surfactant (and it is preferably substantially free of non-siloxane super-wetting surfactant) and from about 30% to about 70%, preferably from about 40% to about 60% by weight of the composition of a co-surfactant, preferably a non-ionic alkyl ethoxylated/propoxylated co-surfactant.

In another preferred embodiment the composition comprises a suds suppresser as co-surfactant and the super-wetting surfactant and the co-surfactant are in a ratio of from about 5:1 to about 1:1. A preferred composition according to this embodiment comprises from about 1% to about 10%, preferably from about 2% to about 6% by weight of the composition of a siloxane, especially methyltrisiloxane, super-wetting surfactant, from about 30% to about 70%, preferably from about 40% to about 60% by weight of the composition of a non-ionic ethoxylated alcohol super-wetting surfactant and from about 10% to about 40%, preferably from about 18% to about 25% by weight of the composition of a suds suppresser.

Preferably the compositions of the invention further comprise one or more additional ingredients selected from the group consisting of: organic carriers, antifoaming agents, humectants, dispersants, crystal growth inhibitors and mixtures therof. Compositions comprising dispersants or crystal growth inhibitors are especially preferred, because they reduce/avoid the formation of water marks on the dried objects.

The compositions of the invention preferably have a pH of from about 6 to about 8 as measured in a 1% by weight aqueous solution at 20° C. This is especially favourable for compositions comprising a siloxane surfactant, because they are not stable at either alkaline or acidic pH.

According to another aspect of the invention, there is provided a unit dose product comprising at least two phases wherein one of the phases comprises the rinse-aid composition of the invention and means for releasing the composition into the rinse cycle of a domestic dishwashing machine. Preferably at least one of the phases which does not comprise the rinse-aid composition, comprises a main wash dishwashing detergent, preferably containing a dispersant or crystal growth inhibitor.

There is also provided a method of cleaning tableware/kitchenware in an automatic dishwashing machine comprising the step of contacting the tableware/kitchenware with an aqueous solution comprising from about 200 ppm to about 450 ppm of the rinse-aid composition of the invention during the rinse cycle of a dishwashing machine to provide total drying. This method permit to achieve total drying even without the application of heat during the drying cycle, amounting to a considerable energy saving. Additionally, the absence of heat in combination with the reduction of water left on the articles after the rinse cycle achieved by this method contributes to ameliorate the corrosion of glass and especially metal items and the damage of wood objects. Surprisingly, it has also been found that white spots occurring in Teflon surfaces after the dishwashing process are eliminated when using the compositions of the invention. Moreover, it has been observed that the compositions of the invention provide care benefits for glass, wood and patterned items.

### DETAILED DESCRIPTION OF THE INVENTION

The present invention provides rinse-aid compositions and uses thereof capable of giving an excellent finishing and care to the dishwashing load. The compositions provide total drying of plastic-ware, even without the application of heat during the drying cycle and also prevent spotting on Teflon surfaces, metal corrosion, pattern damage and provides glass and wood care.

The rinse-aid compositions of the invention comprise super-wetting surfactants and optionally co-surfactants, organic carriers, suds suppressers, humectants, dispersants, crystal growth inhibitors, conventional rinse aid ingredients and mixtures thereof.

1. Super-Wetting Surfactants

Super-wetting surfactants for use herein are preferably selected from the group of i) polyalkylene oxide modified siloxane, preferably methylsiloxane, surfactants containing from 1 to about 9, preferably 3 to about 6 and more preferably 3 siloxanes moieties wherein the polyalkylene oxide residue has the general formula (EO)ₙ(PO)ₘ wherein n is at least 3 and greater than m; ii) non-ionic ethoxylated alcohol surfactants having an average of from about 4 to about 9 moles of EO per mol of alcohol and an average chain length of from about 6 to about 15 carbon atoms; iii) and mixtures thereof. Surfactants belonging to the groups i) and ii) are described hereinbelow (subsections 1.1 and 1.2, respectively).

1.1 Polyoxyalkylene Siloxane Surfactants

The polyoxyalkylene siloxanes suitable for use herein have a polyalkylene oxide residue of formula (EO)ₙ(PO)ₘ wherein n is at least 3 and greater than m, where EO is ethoxy, PO propoxy and n and m are average numbers. Preferably, n is from about 3 to about 9, more preferably from about 4 to about 8 and m is from about 0 to about 4, preferably 1. The trisiloxanes are highly preferred.

The trisiloxane surfactant preferred for use herein is a polyalkylene oxide-modified dimethyltrisiloxane, preferably a linear methyltrisiloxane to which polyethers have been grafted through a hydrosilation reaction. This process results in an alkyl-pendant (AP type) copolymer, in which the polyalkylene oxide groups are attached along the siloxane backbone through a series of hydrolytically stable Si—C bonds. The siloxane surfactants herein described are sold under the brand SILWET® available from Union Carbide or ABIL® polyethersiloxanes available from Goldschmidt Chemical Corp. Preferred siloxane for use herein are Silwet L77, Silwet L7280, Silwet L7607 and Silwet L7608. Silwet L7280 is especially preferred for its environmental profile. Other suitable siloxane surfactants are those supplied by Degusa (sold under the numbers 5840, 5847 and 5878), DowCorning (sold under the numbers DC 5211 and DC5212) and Waker (sold under the number L066).

These compounds are also known by the name of siloxane polyoxyalkylene copolymers, siloxane polyethers, polyalkylene oxide silicone copolymers, silicone poly(oxyalkylene) copolymers, silicone glycol copolymers (or surfactants).

Preferred polyoxyalkylene methylsiloxane surfactants for use herein have a surface tension of less than 25 mN/m, preferably less than 22 mN/m as measured in a 1% by weight aqueous solution at 20° C.

1.2 Non-Ionic Ethoxylated Alcohol Surfactants

The alkyl ethoxylate condensation products of aliphatic alcohols with an average of from about 4 to about 10, preferably form about 5 to about 8 moles of ethylene oxide per mol of alcohol are suitable for use herein. The alkyl chain of the aliphatic alcohol generally contains from about 6 to about 15, preferably from about 8 to about 14 carbon atoms. Particularly preferred are the condensation products of alcohols having an alkyl group containing from about 8 to about 13 carbon atoms with an average of from about 6 to about 8 moles of ethylene oxide per mole of alcohol. Preferably at least 25%, more preferably at least 75% of the surfactant is a straight-chain ethoxylated primary alcohol. It is also preferred that the HLB (hydrophilic-lipophilic balance) of the surfactant be from about 7 to about 13. Commercially available products for use herein include Lutensol®TO series, C113 oxo alcohol ethoxylated, supplied by BASF, especially suitable for use herein being Lutensol®TO7.

2. Co-Surfactants

The level of co-surfactant in the compositions of the invention is preferably from about 5% to about 70%, preferably from about 10% to about 60% and more preferably from about 15% to about 55% by weight of the composition. Preferred co-surfactants for use herein include low-foaming non-ionic ethoxylated/propoxylated fatty alcohol surfactants and non-ionic surfactants capable of acting as suds suppressers for more strongly foaming surfactants.

2.1 Non-Ionic Ethoxylated/Propoxylated Fatty Alcohol Surfactants

The ethoxylated/propoxylated C₆-C₁₈ fatty alcohols are highly preferred surfactants for use as co-surfactants, particularly where water soluble. Preferably the mixed ethoxylated/propoxylated fatty alcohols have an alkyl chain length of from about 8 to about 18, preferably from about 10 to about 14 carbon atoms, an average degree of ethoxylation of from 3 to 15, preferably from about 4 to about 8 and a degree of propoxylation of from about 1 to about 10, preferably from about 1 to about 4. Preferred non-ionic ethoxylated/propoxylated fatty alcohol surfactants are Plurafac surfactants, available from BASF, especially those of the RA series, in particular Plurafac RA30.

2.2 Suds Suppressers Non-Ionic Surfactants

The non-ionic surfactants for use as suds suppressers have a low cloud point. “Cloud point”, as used herein, is a well known property of non-ionic surfactants which is the result of the surfactant becoming less soluble with increasing temperature, the temperature at which the appearance of a second phase is observable is referred to as the “cloud point” (See Kirk Othmer, pp. 360-362). As used herein, a “low cloud point” non-ionic surfactant is defined as a non-ionic surfactant system ingredient having a cloud point of less than 30° C., preferably less than about 20° C., and even more preferably less than about 10° C., and most preferably less than about 7.5° C. Typical low cloud point non-ionic surfactants include non-ionic alkoxylated surfactants, especially ethoxylates derived from primary alcohol, and polyoxypropylene/polyoxyethylene/polyoxypropylene (PO/EO/PO) reverse block polymers. Also, such low cloud point non-ionic surfactants include, for example, ethoxylated-propoxylated alcohol (e.g., Olin Corporation's Poly-Tergent® SLF18) and epoxy-capped poly(oxyalkylated) alcohols (e.g., Olin Corporation's Poly-Tergent® SLF18B series of non-ionics, as described, for example, in U.S. Pat. No. 5,576,281).

Other suitable low cloud point surfactants are the ether-capped poly(oxyalkylated) suds suppresser having the formula: 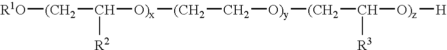
wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point non-ionic surfactants are the ether-capped poly(oxyalkylated) having the formula:
R_{I}O(R_{II}O)ₙCH(CH₃)OR_{III}
wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:
(i) a 4 to 8 membered substituted, or unsubstituted heterocyclic ring containing from 1 to 3 hetero atoms; and
(ii) linear or branched, saturated or unsaturated, substituted or unsubstituted, cyclic or acyclic, aliphatic or aromatic hydrocarbon radicals having from about 1 to about 30 carbon atoms;
(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

If non-ionic suds suppressers are used they are preferably used in a level of from about 5% to about 40%, preferably from about 10% to about 35% and more preferebly form about 15% to about 25% by weight of the composition.

3. Organic Carriers

Organic carriers are preferably low molecular weight primary or secondary alcohols selected from the group consisting of: methanol, ethanol, propanol, isopropanol, glycerol, propylene glycol, ethylene glycol, 1,2-propanediol, sorbitol and mixtures thereof. If used the organic carriers are used in a level of from about 5% to about 40%, preferably from about 10% to about 35% and more preferably form about 15% to about 25% by weight of the composition.

4. Dispersant and Crystal Growth Inhibitors

The function of the dispersant is to suspend the inorganic salts in the wash liquor and minimise their deposition onto dishware. Some dispersants can also act as crystal growth inhibitors.

Suitable for use as dispersants herein are co-polymers synthesised from acrylic acid, maleic acid and methacrylic acid such as Acusol 480N supplied by Rohm & Haas and polymers containing both carboxylate and sulphonate monomers, such as Alcosperse polymers (supplied by Alco).

Preferred crystal growth inhibitors for use herein include organodiphosphonic acids. By organo diphosphonic acid it is meant herein an organo diphosphonic acid which does not contain nitrogen as part of its chemical structure. This definition therefore excludes the organo aminophosphonates, which however may be included in compositions of the invention as heavy metal ion sequestrant components.

The organo diphosphonic acid is preferably a C₁-C₄ diphosphonic acid, more preferably a C₂ diphosphonic acid, such as ethylene diphosphonic acid, or most preferably ethane 1-hydroxy-1,1-diphosphonic acid (HEDP) and may be present in partially or fully ionized form, particularly as a salt or complex.

5. Silicone Antifoaming Agents

Suitable antifoaming agents can be selected from the group consisting of silicon based antifoams, particularly conventional inorganic-filled polydimethylsiloxane antifoam agents, especially silica-filled polydimethylsiloxane antifoam agents as disclosed in U.S. Pat. No. 4,639,489 and U.S. Pat. No. 3,455,839. These and other suitable antifoam agents are commercially available under the tradenames of Silcolapse 431 and Silicone EP 6508 from ICI United States Inc., Wilmington, Del., U.S.A., Rhodosil 454 from Rhone-Poulenc Chemical Co., Monmouth Junction, N.J., U.S.A.; and Silkonol AK 100 commercially available from. Wacker-Chemie G.m.b.H., Munich, Federal Republic of Germany.

6. Humectants

Humectant is a substance which can pick up or emit moisture to the surroundings depending on the surrounding relative humidity. Humectants suitable for use herein include non-aqueous hydrophilic organic solvents inclusive of glycols and polyhydric alcohols, for example sorbitol, glycerol, dipropylene glycol and mixtures thereof.

In a preferred embodiment of the present invention the rinse composition forms part of a multi-phase unit dose product, preferably a dual compartment water-soluble pouch, wherein one of the phases preferably comprises a main wash detergent composition. Preferred compositions and manufacturing methods for unit dose executions are described in WO 02/42408. Any water-soluble film-forming polymer which is compatible with the compositions of the invention and which allows the delivery of the composition into the rinse cycle can be employed in the unit dose embodiment. The film should remains intact during the wash cycle and only dissolves at the beginning of or during the rinse cycle. This can be achieved by modifying the thickness of the film and/or the solubility of the film material. The solubility of the film material can be delayed by for example cross-linking the film as described in WO 02/102,955 at pages 17 and 18. Other water-soluble films designed for rinse release are described in U.S. Pat. No. 4,765,916.

### EXAMPLES

The compositions in the following examples are quoted as percentage by weight of the composition.

| | Example | | | | | | |
|---|---|---|---|---|---|---|---|
| | 1 | 2 | 3 | 4 | 5 | 6 | 7 |
| Silwet L7280¹ | 25 | 20 | 5 | | 20 | 5 | |
| Lutensol TO7² | | 50 | 50 | 50 | 50 | 50 | 50 |
| Plurafac RA30³ | 50 | | | | | | |
| DC-5211⁴ | | | | 5 | | | 5 |
| SLF18⁵ | | 20 | 20 | 20 | | | |
| LF224⁶ | | | | | 25 | 25 | 25 |
| Perfume | 0.1 | 0.1 | 0.1 | 0.1 | 0.1 | 0.1 | 0.1 |
| Dye | 0.1 | 0.1 | 0.1 | 0.1 | 0.1 | 0.1 | 0.1 |
| DI water | 8 | 8 | 8 | 8 | 8 | 8 | 8 |
| DPG⁷ to balance | | | | | | | |

¹Trisiloxane surfactant available from OSi Specialities
²C13 oxo alcohol ethoxylated, available from BASF
³Alcohol alkoxylate available from BASF
⁴Trisiloxane surfactant available from Dow Corning
⁵Low cloud point non-ionic surfactant available form Olin Corp
⁶Fatty alcohol alkoxylated non-ionic surfactant available from BASF
⁷Dipropylene glycol

A load comprising 3 wine glasses, 1 patterned glass, 1 libby glass, 1 large plastic jug, 1 black plate, 1 large plastic lunch box, 1 small plastic lunch box, 1 metal serving spoon were placed in a GE 500 dishwasher. The water temperature was stabilised at a temperature of 37-50° C. using a tank system before pumping it into the dishwasher. The total dishwashing process was about 60 minutes (“normal” cycle) and the heat option of the drying cycle was turned off. 50 grams of Cascade powder (available from Procter and Gamble) were used for the main wash and 2 ml of the rinse-aid composition of Example 1 were delivered into the rinse cycle from the rinse aid reservoir. After completion of the drying cycle, the articles were left in the dishwasher for 5 minutes and then evaluated. Total drying was observed, the articles did not present water marks and were very shining. Similar results can be observed when using compositions 2 to 7.

1. A substantially non-aqueous concentrated rinse-aid composition for the heat-free drying of plastic-ware and other dishwashing items, said composition comprising at least about 20% by weight of one or more super-wetting surfactants.

2. A substantially non-aqueous concentrated rinse-aid composition for the heat-free drying of plastic-ware and other dishwashing items, said composition comprising at least about 20% by weight of one or more super-wetting surfactants and wherein said super-wetting surfactant is selected from the group consisting of:
i) polyoxyalkylene siloxanes wherein the polyalkylene oxide residue has the general formula (EO)ₙ(PO)ₘ wherein n is at least about 3 and greater than m;
ii) non-ionic ethoxylated alcohols having an average of from about 4 to about 10 moles of EO per mol of alcohol and an average chain length of from about 6 to about 15 carbon atoms; and
iii) mixtures thereof.

3. A composition according to claim 2 further comprising a non-super-wetting co-surfactant.

4. A composition according to claim 3 wherein said super-wetting surfactant comprises at least 10% by weight of the composition of said siloxane surfactant and wherein said super-wetting surfactant and said co-surfactant are in a ratio of from about 1:1 to about 1:5.

5. A composition according to claim 3 wherein said co-surfactant is a suds suppresser and the super-wetting surfactant and the co-surfactant are in a ratio of from about 5:1 to about 1:1.

6. A composition according to claim 2 further comprising one or more additional ingredients selected from the group consisting of: organic carriers, antifoaming agents, humectants, dispersants, crystal growth inhibitors and mixtures therof.

7. A composition according to claim 2 having a pH of from about 6 to about 8 as measured in a 1% by weight aqueous solution at 20° C.

8. A unit dose product comprising at least two phases wherein one phase comprises a composition according to claim 2 and a means for releasing said composition into the rinse cycle of a dishwashing machine.

9. A method of cleaning tableware/kitchenware in an automatic dishwashing machine comprising the step of contacting said tableware/kitchenware during the rinse cycle of said dishwashing machine with an aqueous solution, comprising from about 200 ppm to about 450 ppm of a composition comprising at least about 20% by weight of one or more super-wetting surfactants, wherein said contact step occurs prior to the drying cycle.

10. The method according to claim 9, wherein said method reduces one or more of the following problems: spotting on non-stick metal surfaces, metal corrosion, glass corrosion, pattern damage in glass, and damage to wood.
